(19) United States
(12) Patent Application Publication
(10) Pub. No.: US 2011/0005655 A1
(43) Pub. Date: Jan. 13, 2011

(54) SIDE PORTION REINFORCING LAYER AND RUNFLAT TIRE

(76) Inventor: Yoji Imoto, Hyogo (JP)

Correspondence Address: BIRCH STEWART KOLASCH & BIRCH, PO BOX 747, FALLS CHURCH, VA, 22040-0747, US

(21) Appl. No.: 12/677,091

(22) PCT Filed: Dec. 18, 2008
(86) PCT No.: PCT/JP2008/073072

§ 371 Date: Mar. 8, 2010

(30) Foreign Application Priority Data
Jan. 4, 2008 (JP) 2008-000113

(51) Int. Cl. B60C 17/06; B29D 30/08

(52) U.S. Cl. 152/517; 156/123

(57) ABSTRACT

A runflat tire improved in durability which and increased in running distance and velocity at the time of puncture is provided. A side portion reinforcing layer (11) for a runflat tire, the layer being made of a rubber composition prepared by blending 0.1 to 50 parts by mass of a reinforcing material of polyparaphenylene terephthalamide based on 100 parts by mass of a rubber component comprising 20 to 80% by mass of a natural rubber and/or a polyisoprene rubber and 80 to 20% by mass of a polybutadiene rubber, and a runflat tire using the same.

### TECHNICAL FIELD

The present invention relates to a side-reinforcing rubber layer excellent in runflat performance, and a runflat tire using the same.

### BACKGROUND ART

Conventional runflat tires have a structure containing high-hardness rubber for side reinforcement disposed inside the sidewall portions and enable running a predetermined distance to a service station even in a state such that the internal pressure has been reduced due to puncture. The installation of such a runflat tire causes no necessity of keeping a spare tire and thus a weight reduction of the whole vehicle can be expected. However, the velocity and the running distance of a runflat tire is not sufficient under puncture conditions, and thus an improvement in durability of runflat tires has been desired.

Examples of an effective means for improving durability of a runflat tire include a method in which a rubber for reinforcement is thickened to restrain deformation, so that breakage due to deformation is prevented. This method, however, results in an increase in the mass of the tire, so that the originally demanded weight reduction of a runflat tire cannot be achieved.

Further, examples of the effective means for improving durability of a runflat tire include a method in which the amount of a reinforcing filler, such as carbon black, is increased and the filler is added to increase the hardness of the rubber for reinforcement and thereby restrain deformation. An improvement in runflat durability, however, cannot be expected so much because a great load is put on processes such as kneading and extruding and a heat build-up property increases in physical properties after vulcanization.

In order to improve the durability of a runflat tire, it has been attempted to use large amounts of a vulcanizing agent and a vulcanization accelerator without increasing the amount of carbon black. This technology can increase the vulcanization density and can reduce deformation and heat build-up; however, it reduces the elongation of the rubber to cause a tendency that the strength at break decreases. On the other hand, a technology of blending a lamellar natural ore such as mica into a rubber for sidewalls of a tire has also been proposed. It, however, is not strong enough for supporting a load because of its low hardness even if it is used as a rubber for side reinforcement because a rubber composition is required to have flex resistance.

Japanese Patent Laying-Open No. 2005-280459 (patent document 1) discloses a runflat tire that possesses a side-reinforcing rubber layer with an approximately crescent cross-sectional shape and that is disposed on the inner side surface and within a sidewall region of a carcass, wherein the side-reinforcing rubber layer has an inner side rubber portion that is disposed on an inner side of a tire axial direction and that has a JIS A hardness of 70 to 95° and an outer side rubber portion that is disposed on an outer side of the tire axial direction and that has a JIS A hardness which is less than that of the inner side rubber portion and is 60 to 75°.

Japanese Patent Laying-Open No. 2007-161071 (patent document 2) discloses a runflat tire that possesses a side-reinforcing rubber layer with a crescent cross-sectional shape which is disposed within a sidewall portion and on the inner side of a carcass, wherein the carcass is composed of a carcass ply composed of carcass cords which are arranged at an angle of 70 to 90° with respect to the tire circumferential direction and are coated with a topping rubber, and aramid fiber cords or polyethylene naphthalate fiber cords are used as the carcass cords.
Patent document 1: Japanese Patent Laying-Open No. 2005-280459
Patent document 2: Japanese Patent Laying-Open No. 2007-161071

### DISCLOSURE OF THE INVENTION

### Problems to be Solved by the Invention

The present invention relates to a rubber composition for side reinforcement of a runflat tire, the rubber composition being low in heat build-up property and high in strength, and it particularly provides a runflat tire which has been improved in durability and increased in running distance and velocity at the time of puncture due to the use of the composition.

Furthermore, in light of a recent trend of increasing in velocity and running distance during runflat operations, a further improvement in both runflat durability and steering stability has been demanded strongly. Objects include to increase steering stability and durability during runflat operations while reducing the weight of a runflat tire and to provide a runflat tire which achieves increase in both velocity and running distance during runflat operations by basically using, as carcass cords, aramid fiber cords which are superior in heat resistance and higher in elasticity in comparison to rayon fiber cords.

### Means for Solving the Problems

The present invention relates to a side portion reinforcing layer for a runflat tire, the layer containing a rubber composition prepared by blending 0.1 to 50 parts by mass of a reinforcing material of polyparaphenylene terephthalamide based on 100 parts by mass of a rubber component containing 20 to 80% by mass of a natural rubber and/or a polyisoprene rubber and 80 to 20% by mass of a polybutadiene rubber.

The reinforcing material is preferably polyparaphenylene terephthalamide (PPTA) and/or a masterbatch containing the polyparaphenylene terephthalamide (PPTA) and stearic acid. The complex elastic modulus (E*) of the rubber composition is preferably 10 Mpa or more.

The present invention further relates to a runflat tire contains a carcass extending from a tread portion to a bead core of a bead portion via a sidewall portion, a belt layer disposed inside the tread portion and on the radially outward of the carcass, and a side portion reinforcing layer which is disposed inside both the sidewall portion and the carcass and has a crescent cross-sectional shape extending from the center portion having a maximum thickness toward both the radially inward and the radially outward with gradual decrease in thickness, wherein the side portion reinforcing layer is formed from the rubber composition.

It is preferable that the carcass of the runflat tire of the present invention is made of a carcass ply made of a carcass cord which is arranged at an angle of 45 to 90° with respect to the circumferential direction of the tire and is covered with a topping rubber, and the carcass cord is an aramid fiber cord. The carcass cord preferably has a two-strand twist structure in which two first-twisted filament bundles are twisted together by second-twisting.

Further, a preferable embodiment of the present invention is a runflat tire, wherein the carcass cord has a twisting coefficient T represented by the following formula ranging from 0.5 to 0.8:

T=N×√{(0.125×D/2)/ρ}×10⁻³ (1)

wherein N is a second twisting number (turns/10 cm), D is a total nominal decitex (fineness) and ρ is a specific gravity of a cord material.

The topping rubber of the carcass ply preferably has a complex elastic modulus (E*) within a range of 5 to 13 MPa.

Further, a preferable embodiment of the present invention is a runflat tire (1) according to any one of claims 4 to 8, wherein in the tire meridian cross section at a normal internal pressure condition where the tire is attached to a regular rim and inflated at a normal internal pressure, when a point on the tire external surface which is apart from the tire equatorial plane C by a distance SP which is 45% of the tire maximum section width SW is assumed to be P, the radius of curvature, RC, of the tire external surface decreases gradually from an equatorial point CP at which the tire external surface intersects with the tire equatorial plane C to the point P, and the following relationships are satisfied when Y60, Y75, Y90 and Y100 denote, respectively, radial distances between the points on the tire external surface apart from the tire equatorial plane C by 60%, 75%, 90% and 100% of the half width (SW/2) of the tire maximum section width SW and the normal CX with respect to the tire equatorial plane C at the equatorial point P, and SH denotes the tire section height:

0.05<Y60/SH≦0.1

0.1<Y75/SH≦0.2

0.2<Y90/SH≦0.4

0.4<Y100/SH≦0.7

The “regular rim” referred to herein is a rim determined for each tire by a standard system including a tire standard and it means, for example, a standard rim in JATMA, a “Design Rim” in TRA, or a “Measuring Rim” in ETRTO. Further, the “normal internal pressure” is a pneumatic pressure determined for each tire by the standards, and it is a maximum pneumatic pressure in JATMA, a maximum value given in a table “TIRE LOAD LIMITS AT VARIOUS COLD INFLATION PRESSURES” in TRA, and an “INFLATION PRESSURE” in ETRTO. As to a tire for passenger vehicles, it is assumed to be 180 kPa.

### Effects of the Invention

The present invention can obtain a runflat tire excellent in running durability during puncture, namely, runflat property because of the use of a side portion reinforcing layer (11) for a runflat tire, the layer being made of a rubber composition prepared by blending 0.1 to 50 parts by mass of a reinforcing material of polyparaphenylene terephthalamide (PPTA) based on 100 parts by mass of a rubber component comprising 20 to 80% by mass of a natural rubber and/or a polyisoprene rubber and 80 to 20% by mass of a polybutadiene rubber.

The adoption of an aramid fiber cord particularly superior in heat resistance as a carcass cord makes it possible to inhibit cord damage caused by temperature increase which occurs during runflat running. Moreover, since an aramid fiber cord is of high elasticity and can increase the load supporting capability, it is possible to reduce the number of plies, i.e., to reduce tire deformation during runflat operations while reducing the weight of the tire, and it is possible to increase the runflat durability in combination with the improvement in heat resistance. Moreover, it is also possible to improve the steering stability during runflat running and, therefore, to achieve increase in velocity and running distance during runflat running.

### BRIEF DESCRIPTION OF THE DRAWINGS

FIG. 1 is a meridian section which illustrates one example in a case where the pneumatic tire of the present invention is a runflat tire.

FIG. 2 is a schematic diagram of a carcass cord.

FIG. 3 is a diagram which illustrates a profile of a tire external surface.

FIG. 4 is a diagram which illustrates the range of RYi in each position on the tire external surface.

### DESCRIPTION OF THE REFERENCE SIGNS

1: runflat tire, 2: tread portion, 3: sidewall portion, 4: bead portion, 5: bead core, 6: carcass, 7: tread-reinforcing cord layer, 8: bead apex, 9: belt, 10: band, 11: side portion reinforcing layer, 20: carcass cord, 21: strand.

### BEST MODES FOR CARRYING OUT THE INVENTION

The present invention is directed to a side portion reinforcing layer of a runflat tire, the layer being made of a rubber composition prepared by blending 0.1 to 50 parts by mass of a reinforcing material containing polyparaphenylene terephthalamide (PPTA) based on 100 parts by mass of a rubber component containing 20 to 80% by mass of a natural rubber and/or a polyisoprene rubber and 80 to 20% by mass of a polybutadiene rubber.

<Rubber Component>

In the natural rubber of the side portion reinforcing layer, the content of the natural rubber (NR) and/or the polyisoprene rubber (IR) in the rubber component preferably is 20% by mass to 80% by mass. When the content of the natural rubber (NR) and/or polyisoprene rubber (IR) is less than 20% by mass, the elongation percentage of a rubber composition is low and the productivity tends to decrease. When the content exceeds 80% by mass in the rubber component, there is a tendency that the rubber is degraded and the runflat performance deteriorates due to the heat generation during runflat running.

The polybutadiene rubber is contained in the rubber component in an amount of 20 to 80% by mass, and preferably 30 to 70% by mass. When the SBR including an SPBd crystalpolybutadiene rubber is less than 20% by mass, the rigidity of the rubber composition cannot be improved; on the other hand, when the polybutadiene rubber exceeds 80% by mass, the elongation percentage decreases and the runflat property deteriorates. Herein, for the polybutadiene rubber, a polybutadiene rubber which contains 1,4-cis-polybutadiene having a cis-bond content of 80% by mass or more, a polybutadiene rubber having a trans-bond content of 30% by mass or less, 1,2-polybutadiene (1,2BR), and 1,2-syndiotactic crystal (henceforth, referred to also as “SPBd crystal”) can be used. It contains the SPBd crystal in an amount of 5 to 60% by mass, preferably 10 to 40% by mass. If the content of the SPBd crystal is less than 5% by mass, the strength and the rigidity are insufficient. If the content of the SPBd crystal is more than 60% by mass, the processability tends to deteriorate.

In the present invention, styrene-butadiene copolymer rubber (SBR), syndiotactic crystal-containing SBR, acrylonitrile-butadiene copolymer rubber (NBR), chloroprene rubber (CR), styrene-isoprene-butadiene copolymer rubber (SIBR), styrene-isoprene copolymer rubber, isoprene-butadiene copolymer rubber, etc. can be used as the rubber component. One or two kinds of these rubber components are preferably mixed in a range of 20% by mass or less of the rubber component.

<Reinforcing Material of Polyparaphenylene Terephthalamide (PPTA)>

The rubber composition of the side portion reinforcing layer contains a reinforcing material of polyparaphenylene terephthalamide (PPTA) in an amount of 0.1 to 50 parts by mass based on 100 parts by weight of a rubber component. The reinforcing material is used in the form of polyparaphenylene terephthalamide (PPTA) itself or a masterbatch containing polyparaphenylene terephthalamide (PPTA) and stearic acid.

Polyparaphenylene terephthalamide (PPTA) is an aromatic polyamide having the following formula (1) or formula (2), wherein a molecular unit is extended at para positions or meta positions. The molecular bonding units m and n in the formula (1) and the formula (2) are usually within a range of 10 to 10,000. The polyparaphenylene terephthalamide (PPTA) can also have a structure in which molecules having molecular units extending at para positions and molecules having molecular units extending at meta positions are mixed.

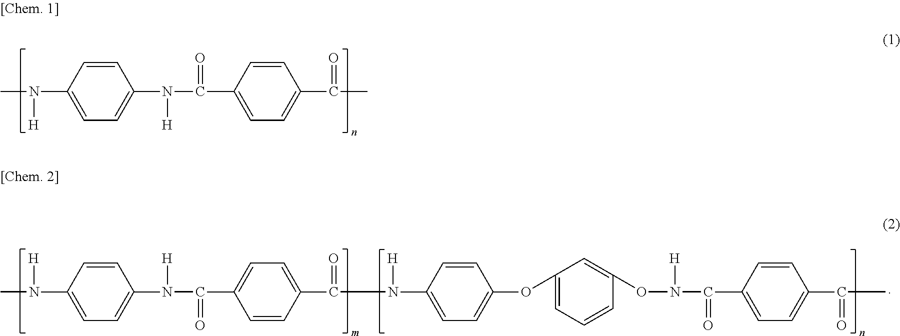

In the present invention, polyparaphenylene terephthalamide (PPTA) is used alone or it is preferably used in the form of a masterbatch containing stearic acid. The masterbatch contains polyparaphenylene terephthalamide (PPTA) in an amount of 10 to 80% by mass, preferably 30 to 70% by mass, and also contains stearic acid in an amount of 10 to 60% by mass. Moreover, the masterbatch preferably contains 0.5 to 15% by mass of a silane coupling agent, 0.1 to 2% by mass of a vulcanization accelerator and 0.05 to 2% by mass of sulfur.

Examples of the silane coupling agent include bis(3-triethoxysilylpropyl)tetrasulfide, bis(3-trimethoxysilylpropyl)tetrasulfide, bis(2-triethoxysilylpropyl)tetrasulfide, 3-mercaptopropyltriethoxysilane, and 2-mercaptoethyltrimethoxysilane. The amount of the silane coupling agent incorporated is within the range of 2 parts by mass to 20 parts by mass based on 100 parts by mass of silica.

As to the vulcanization accelerator, a sulfenamide-based accelerator, for example, is used most frequently as a delayed vulcanization accelerator because scorching hardly occurs in the preparation process and it is excellent in vulcanization properties. As to rubber properties after vulcanization, a rubber compound to which a sulfen amide-based accelerator is used has low exothermic properties in response to distortion caused by external force. Therefore, the durability of a runflat tire is improved.

Examples of the sulfenamide-based accelerator include TBBS (N-tert-butyl-2-benzothiazolylsulfenamide), CBS (N-cyclohexyl-2-benzothiazolylsulfenamide) and DZ (N,N′-dicyclohexyl-2-benzothiazolylsulfenamide). As other vulcanization accelerators, for example, MBT (mercaptobenzothiazole), MBTS (dibenzothiazyldisulfide), DPG (diphenyl guanidine) and the like can be used.

Polyparaphenylene terephthalamide (PPTA) reacts with a silane coupling agent in the presence of a vulcanization accelerator and sulfur. For example, when a silane coupling agent having a terminal SH group is used, SH groups react also with OH groups on the surfaces of carbon black, silica, etc., so that polyparaphenylene terephthalamide (PPTA) is bonded to carbon black and silica via the silane coupling agent and, thereby, the reinforcing effect can be enhanced more.

In order to adjust a rubber composition using the masterbatch, it can be blended simultaneously with a filler such as carbon black and silica. It is noted that the blended amount of the silane coupling agent to be blended separately to the rubber composition should be adjusted in view of the amount of silica contained in the masterbatch. The discharging temperature of the rubber composition after kneading is usually set at 130° C. or more, and it is preferable to vulcanize it within 72 hours after the kneading.

<Carbon Black>

Carbon black used for the present invention is not particularly limited and is preferably soft carbon such as FEF and FPF in order to maintain the rubber composition at low heat build-up. For example, the nitrogen absorption specific surface area (N₂SA) is 30 m²/g or more, preferably 35 m²/g or more, If the N₂SA is less than 30 m²/g, reinforcement runs short, so that sufficient durability cannot be obtained. The N₂SA of the carbon black is 100 m²/g or less, preferably 80 m²/g or less, and more preferably 60 m²/g or less. If the N₂SA is more than 100 m²/g, the heat build-up property becomes unfavorably high.

The dibutyl phthalate oil absorption (DBP oil absorption) of the carbon black is 50 ml/100 g or more, and preferably 80 ml/100 g or more. If the DBP oil absorption is less than 50 ml/100 g, it becomes difficult to obtain sufficient reinforcement,

The content of the carbon black is 10 parts by mass or more, preferably 20 parts by mass or more, and more preferably 30 parts by mass or more based on 100 parts by mass of the rubber component. If the content of carbon black is less than 10 parts by mass, sufficient rubber strength cannot be obtained. Further, the content of carbon black is 80 parts by mass or less, preferably 70 parts by mass or less, and more preferably 60 parts by mass or less. If the content of carbon black is more than 80 parts by mass, blending viscosity increases, so that it becomes difficult to perform kneading and extruding of the rubber and additionally the heat build-up during runflat running increases.

<Blending Agent>

Sulfur or a sulfur compound used for the rubber composition of the present invention is preferably insoluble sulfur from the viewpoint of restraining the surface precipitation of sulfur. With regard to the insoluble sulfur, the average molecular weight thereof is preferably 10000 or more, and particularly preferably from 100000 to 500000, and particularly preferably 300000 or less. If the average molecular weight is less than 10000, decomposition at low temperatures tends to occur and the sulfur tends to precipitate on the surface. If it is more than 500000, dispersability in the rubber tends to decrease.

The blended amount of sulfur or a sulfur compound is preferably 2 parts by mass or more, and more preferably 3 parts by mass or more, and is preferably 10 parts by mass or less, and more preferably 8 parts by mass or less. If the amount of sulfur or a sulfur compound is less than 2 parts by mass, sufficient hardness tends to fail to be obtained. If it exceeds 10 parts by mass, the storage stability of an unvulcanized rubber tends to deteriorate.

Furthermore, the side-reinforcing rubber composition of the present invention may contain zinc oxide, wax, stearic acid, oil, antioxidants, etc. that are usually used for rubber compositions unless the effects of the present invention is impaired.

<Filler>

In the rubber composition of the present invention, silica that is used for general-purpose rubber can be used. Examples thereof include dry-method white carbon, wet-method white carbon and colloidal silica. The wet-method white carbon, which contains hydrous silicic acid as a main component, is preferable among them.

In the present invention, a lamellar natural ore, for example, mica such as kaolinite, sericite, phlogopite, and muscovite can be blended. The aspect ratio (the ratio of the maximum diameter to the thickness) of a lamellar natural ore preferably is 3 or more in view of increasing rubber hardness. As to the average particle diameter of the lamellar natural ore, an ore which is as large as 2 μm to 30 μm is suitably used. It can be blended in an amount of 5 parts by mass to 120 parts by mass based on 100 parts by mass of the rubber component.

<Viscoelastic Property of Rubber Composition>

The rubber composition of the side portion reinforcing layer has a complex elastic modulus (E*) of 10 Mpa or more. Moreover, the loss elastic modulus (E″) and the complex elastic modulus (E*) preferably satisfy the following formula:

E″/(E*)²≦7.0×10⁻⁹ Pa⁻¹.

Particularly, E″/(E*)²≦6.8×10⁻⁹ Pa⁻⁴ is preferable.

When (E*) is less than 10 Mpa, the side portion reinforcing layer deforms greatly during runflat operations. Moreover, when E″/(E*)² is larger than 7.5×10⁻⁹ Pa⁻¹, there is a tendency that the amount of heat generated due to the deformation of the side portion reinforcing layer which occurs during runflat operations increases, so that thermal degradation of the rubber is promoted, resulting in breakage.

<Runflat Tire>

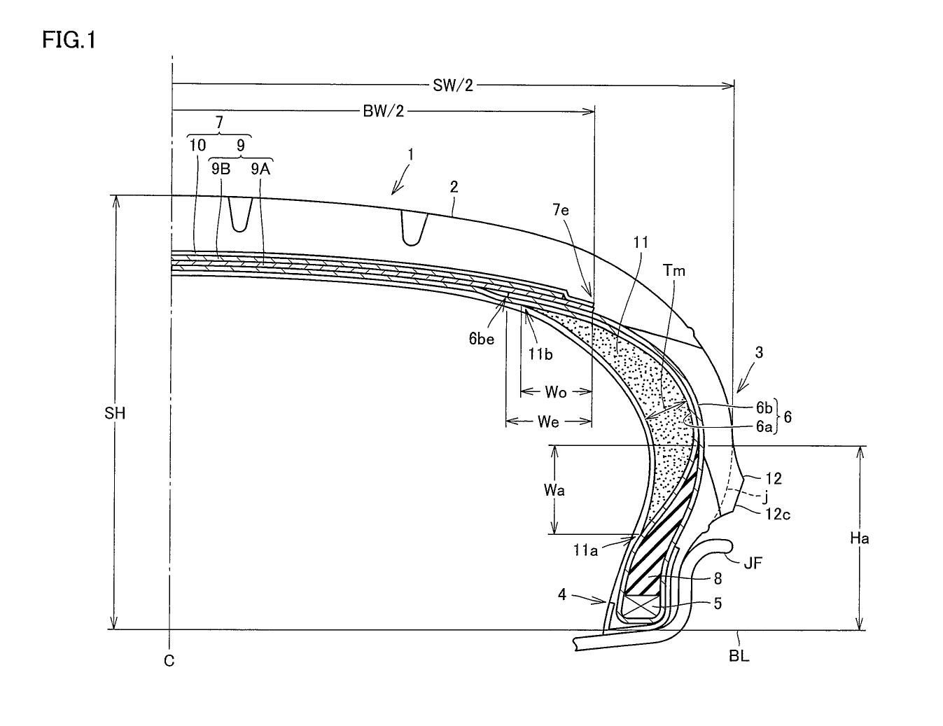

One embodiment of the present invention is explained with reference to examples illustrated. FIG. 1 is a tire meridian sectional view in a normal internal pressure state which illustrates a runflat tire 1 of the present invention.

In FIG. 1, the runflat 1 of this embodiment has a carcass 6 that extends from a tread portion 2 to a bead core 5 of a bead portion 4 via a sidewall portion 3, and a tread-reinforcing cord layer 7 that is disposed inside the tread portion 2 and on the outside in the radial direction of the carcass 6.

The carcass 6 is formed from one or more carcass plies made of carcass cords which are arranged at an angle of 45 to 90° with respect to the circumferential direction of the tire and are covered with a topping rubber. In this example is illustrated a sample formed from one carcass ply in which carcass cords are arranged at an angle of 80 to 90° . The carcass ply is composed of a ply main body portion 6a extending between the bead cores 5, 5, and ply turnup portions 6b that are continuously formed at both ends of the ply main body portion and are each turned up around a bead core 5 from the axially inside to the axially outside of the tire.

In addition, between the ply main body portion 6a and each of the ply turnup portions 6b is disposed a bead apex 8 for reinforcing a bead, the bead apex being made of for example, a hard rubber having a rubber hardness of 65 to 98° and extending taperedly from each of the bead core 5 radially outwardly. In this description, the “rubber hardness” means a hardness measured using a durometer type A at a temperature of 23° C. While the radial height Ha of the bead apex 8 from a bead base line BL is not particularly limited, if the height is excessively small, the runflat durability may be insufficient, and if the height is extremely large, this may result in an excessive increase in tire weight or a deterioration in riding comfort. From this point of view, it is preferable that the height Ha of the bead apex 8 be 10 to 60%, more preferably 20 to 50%, of the tire section height H.

This example has a turnup structure with a so-called “super high turnup” in which the ply turnup portion 6b of the carcass 6 turns up radially outward beyond the bead apex 8 and terminates with the outer end portion 6be thereof sandwiched between the ply body portion 6a and the tread-reinforcing cord layer 7. Thereby, the sidewall portion 3 can be effectively reinforced by the use of one carcass ply. Moreover, since the outer end portion 6be of the ply turnup portion 6b is located apart from the sidewall portion 3 that is greatly bent during runflat operations, damages developing from the outer end portion 6be can be restrained well. The axial width We of the overlapping part of the ply turnup portion 6b and the tread-reinforcing cord layer 7 is preferably 5 mm or more, more preferably 10 mm or more, and it is preferably 40 mm or less, and more preferably 30 mm or less, from the viewpoint of weight reduction. In the case of forming the carcass 6 from a plurality of carcass plies, it is preferable that at least one carcass ply have this structure.

The tread-reinforcing cord layer 7 is, in this example, formed from a belt 9 which is superposed on the carcass 6 and a band 10 which is superposed outside the belt. The belt 9 is formed from two or more belt plies, in this example two belt plies 9A and 9B, made of belt cords which are arranged at an angle of for example, 10 to 45° with respect to the circumferential direction of the tire and are covered with a topping rubber. Belt cords in one ply intersect with belt cords in another ply to increase the belt rigidity, so that the tread portion 2 is almost entirely reinforced firmly by a hoop effect.

Moreover, the band 10 is formed of one of more band plies composed of band cords spirally wound at an angle of 5° or more with respect to the tire circumferential direction and covered with a topping rubber. It restricts the belt 9 to increase steering stability, high-speed durability, etc. The band ply includes a pair of left and right edge band plies which cover only the axial outer ends of the belt 9 and a full band ply which covers the belt 9 over the almost entire width thereof. These are used singly or in combination. In this example is illustrated a sample in which the band is made from one full band ply. The tread-reinforcing cord layer 7 can be formed from a belt 9 only or, alternatively, may be formed from a band 10 only.

In the side wall portion 3 is disposed a side portion reinforcing layer 11 for securing a runflat function. The side portion reinforcing rubber layer 11 has a crescent sectional shape extending so that the thickness thereof may gradually decrease from a central portion having the maximum thickness Tm toward an inner end 11a and an outer end 11b in the radial direction of the tire. The inner end 11a is located inside the outer end of a bead apex 8 with respect to the tire radial direction, and the outer end 11b is located inside the outer end 7e of a tread-reinforcing cord layer 7 with respect to the tire axial direction. At this time, it is preferable to adjust the radial width Wa of the overlap of the tire side portion reinforcing layer 11 and the bead apex 8 to 5 to 50 mm and the axial width Wo of the overlap of the side portion reinforcing layer 11 and the tread-reinforcing cord layer 7 to 50 mm or less. The difference in rigidity between the outer end 11b and the inner end 11a is thereby restrained from generating.

In this example, the side portion reinforcing layer 11 is disposed inside the ply main body portion 6a of the carcass 6 (i.e., on the tire cavity side) and, therefore, when the sidewall portion 3 is subject to flexural deformation, mainly a compressive load acts on the side portion reinforcing layer 11 and mainly a tensile load acts on the ply body 6a which contains a cord material. Since rubber is resistant to a compressive load and a cord material is resistant to a tensile load, the configuration of the side portion reinforcing rubber layer 11 like that mentioned above can efficiently enhance the flexural rigidity of the sidewall portion 3, thus effectively decreasing the vertical flexure of a tire during runflat running.

In addition, the side portion reinforcing layer 11 can use a rubber blending with a high hardness and a rubber blending with a low hardness. A rubber blending with a high hardness restrains compressive strain during runflat running to maintain the runflat performance. It is preferable for the rubber blending in this situation that the complex elastic modulus (E*) be within the range of 12 to 18 MPa and the tan δ be within the range of 0.06 to 0.1. On the other hand, a rubber blending with a low hardness reduces the exothermic property during runflat running to maintain the runflat performance. It is preferable for the rubber blending in this situation that the complex elastic modulus (E*) be within the range of 5 to 11 MPa and the tan δ be within the range of 0.02 to 0.06.

The maximum thickness of the side portion reinforcing layer 11, which may vary depending on the size, category, etc. of a tire, is preferably adjusted to within the range of 5 to 20 mm for a tire for passenger cars.

In this example, a case where a rim-protecting rib 12 is formed projectingly on the bead portion 4. This rim protect rib 12 is a rib projecting from a base profile line “j” to cover a rim flange JF. It has a trapezoidal cross section which is enclosed by a projecting face portion 12c which surmount the tip of the rim flange JF and projects most outwardly with respect to the tire axial direction, a radially inner slope which smoothly continues from the top face portion 12c to the outer surface of the bead portion, and a radially outer slope portion which smoothly continues from the top face portion 12c to the base profile line “j” in the vicinity of a tire maximum width point. The radially inner slope 11 is defined by a concave arc-like face having a larger radius of curvature than an arc-like portion of the rim flange IF, and serves to protect the rim flange JF from stones in normal running condition. On the other hand, it can serve to decrease the bead deformation to improve the steering stability and the runflat durability during runflat operations because the radially inner slope portion comes into contact with the rim flange IF while leaning against the arc-like portion of the rim flange JF.

In addition, in the present invention, in order to improve the runflat steering stability and the runflat durability, it is preferable to use an aramid fiber for the carcass cord.

The aramid fiber is known as a highly elastic fiber and can increase the load supporting ability of a tire by being used for a carcass cord of a runflat tire 1. Therefore, it is possible to reduce the deformation of a tire during runflat operations while, for example, reducing the number of carcass plies, making carcass cords thinner, and/or reducing the cord arrangement density (the number of cord ends). Aramid fiber exhibits a smaller decrease in elastic modulus than other organic fiber cord materials even under high temperatures of 100 to 150° C., and therefore has a characteristic in that it is excellent in heat resistance. It, thus, can prevent carcass cords from damaging due to their deterioration in strength even under increase in tire temperature during runflat running, or prevent the tire volume from increasing due to decrease in elastic modulus, or prevent the tire temperature from further increasing due to the increase in tire deformation. As a result, it is possible to improve the runflat durability. Moreover, since it is possible to increase the tire rigidity while maintaining a high elastic modulus even under increase in tire temperature, it is also possible to improve the steering stability during runflat operations. The increase in velocity and running distance during runflat running is thereby achieved.

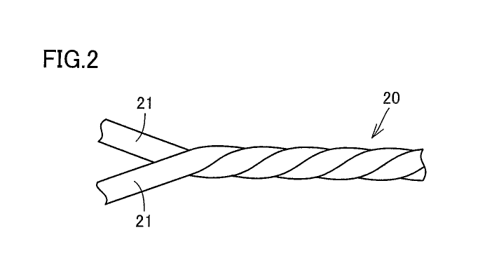

Aramid fiber, however, tends to be poor in fatigue resistance due to its high elastic modulus. Therefore, in this example, a two-strand twist structure obtained by twisting two first-twisted aramid fiber strands 21 together by second twisting as illustrated in FIG. 2 is employed for carcass cords 20 and the twisting is performed at a twisting coefficient T which is higher than usual.

As well known in the art, the “twisting coefficient T” is represented by the following formula (1), where the number of first twists of a cord is denoted by N (unit: turns/10 cm), the total nominal decitex per one cord is represented by D (unit: dtex), and the specific gravity of the cord material is denoted by ρ:

T=N×√{(0.125×D/2)/ρ}×10⁻³ (1)

By increasing the twisting coefficient T to within the range of 0.5 to 0.8, it is possible to improve the fatigue resistance, which is a drawback of aramid fiber cords and it becomes possible to greatly improve the runflat durability in comparison to conventional rayon cords. If the twisting coefficient T of the carcass cord 20 is less than 0.5, the effect of improving the fatigue resistance is small and it is impossible to increase the runflat durability sufficiently. If the twisting coefficient T is more than 0.8, the twist processing of a cord becomes difficult, so it is industrially disadvantageous. Particularly, the lower limit of the twisting coefficient T is preferably 0,6 or more, and the fatigue durability of a cord is thereby improved more and the runflat durability can be improved more.

In the carcass cords 20, in order to demonstrate an excellent reinforcing effect by taking advantage of such high elasticity, which is an important property of aramid fiber, the two-strand twist structure is adopted. In this occasion, while so-called “balanced twisting” in which the number of first twists is the same as the number of the second twists is preferable, the number of first twists may be differentiated from the number of second twists as long as the twist number ratio (first twist number/second twist number) falls within the range of from 0.2 to 2.0, preferably from 0.5 to 1.5.

The total nominal decitex D (fineness) is not particularly limited, but it is preferably within the range of 1500 to 5000 dtex for runflat tires. The product of the number of cord ends n (cords/5 cm) and the total nominal decitex D in the carcass ply is preferably within the range of 70000 to 150000. If it is less than 70000, the runflat durability or the steering stability becomes insufficient even if aramid fiber cords are used. On the other hand, if it is greater than 150000, the carcass rigidity becomes excessively high, resulting in deterioration in riding comfort, and the mass and the cost will increase unnecessarily. From such a point of view, the lower limit of the product D×n more preferably is 100000 or more, and the upper limit more preferably is 120000 or less.

Damage to the carcass cords 20 caused by fatigue resistance occurs easily at a part which receives a compressive strain when a tire deforms, that is, at a bead side portion of a ply turnup portion 6b. In this example, however, a rim-protecting rib 12 is formed projectingly on the bead portion 4 as described above. Therefore, bead deformation which occurs during runflat operations is reduced, so that compressive strain hardly acts on the carcass cords 20. As a result, it is possible to further restrain the fatigue damage of carcass cords 20 in the use of aramid fiber and further improve the runflat durability. In other words, from the viewpoint of reduction in fatigue damage of cords, it is preferable, in a tire containing aramid fiber carcass cords 20, to use a rim-protecting rib 12.

Furthermore, in this example, a rubber having a complex elastic modulus E* within the range of 5 to 13 MPa, that is, a rubber with a higher elasticity than those of conventional carcass topping rubbers is addopted as a topping rubber of the carcass ply. It is noted that conventional carcass topping rubbers have a complex elastic modulus E* of about 3.8 MPa. By adopting a highly elastic rubber as a topping rubber as mentioned above, it is possible to reduce the strain which acts on the carcass cords 20 and thereby to achieve further improvement in runflat durability. If the complex elastic modulus E* is less than 5 MPa, the above-mentioned effect is not expectable; conversely, if it exceeds 13 MPa, the rubber becomes excessively hard, so that the riding comfort is deteriorated drastically. From such a viewpoint, the lower limit of the complex elastic modulus E* is preferably 5.5 MPa or more, more preferably 6 MPa or more. The upper limit is preferably 11 MPa or less, and more preferably 9 MPa or less.

In the tire meridian cross section of the aforementioned normal internal pressure condition, the profile of the tire external surface 2A is formed of a curved surface defined by a plurality of arcs different in radius of curvature. It is preferable to form the profile by a curved surface defined by a plurality of arcs whose radius of curvature R decreases gradually from the equatorial point CP which is an intersection of the tire external surface 2A and the tire equatorial plane C toward the grounding end. It, thereby, is possible to minimize the rubber volume of the side portion reinforcing layer 11, so that the weight of the tire can be reduced and the riding comfort can be improved. In particular, the adoption of a special profile like that proposed in Japanese Patent No. 2994989 makes it possible to exhibit the above-mentioned effect at a high level.

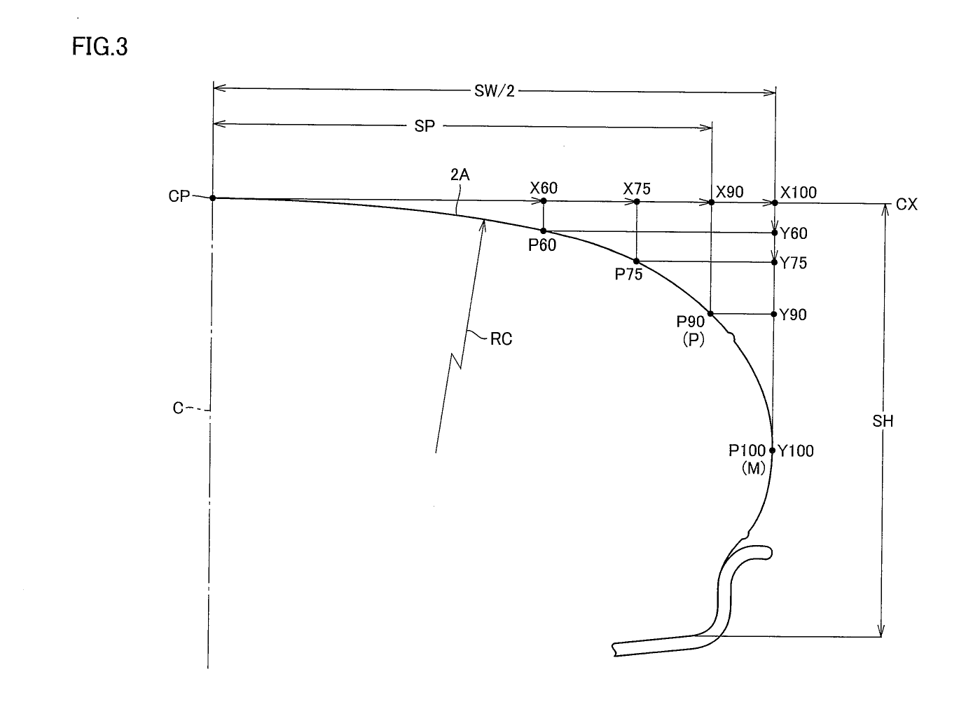

A detailed explanation is as follows. First of all, when a point on the tire external surface 2A which is apart from the tire equatorial plane C by a distance SP which is 45% of the tire maximum section width SW is assumed to be P as shown in FIG. 3, the radius of curvature RC of the tire external surface 2A is set so as to decrease gradually from the tire equatorial point CP to the point P. The “tire maximum section width SW” denotes the maximum width on the base profile line “j” (see FIG. 1) of the tire external surface 2A, and the base profile line “j” denotes a smooth profile line of the tire external surface 2A resulting from elimination of local concave and convex parts such as fine ribs and grooves showing letters, figures and marks for decoration or information, rim-protecting rib for preventing a rim from coming off and side-protecting rib 12 for protecting from a cut.

Further, points on the tire external surface 2A apart from the tire equatorial plane C by distances X60, X75, X90 and X100 which are 60%, 75%, 90% and 100% of the half width (SW/2) of the tire maximum section width SW, respectively, are assumed to be P60, P75, P90 and P100. Moreover, radial distances between the tire equatorial point CP and each of the points P60, P75, P90 and P100 on the tire external surface 2A are assumed to be Y60, Y75, Y90 and Y100, respectively.

Furthermore, the tire section height, which is the radial distance from the bead base line BL to the tire equatorial point CP at the above-described normal internal pressure is assumed to be SH. At this time, the radial distances Y60, Y75, Y90 and Y100 satisfy the following relationships:

0.05<Y60/SH≦0.1

0.1<Y75/SH≦0.2

0.2<Y90/SH≦0.4

0.4<Y100/SH≦0.7

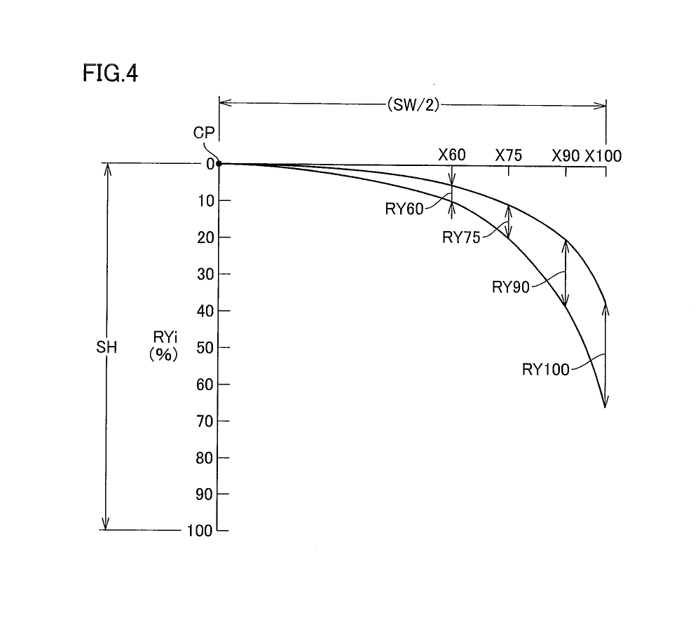

When the range RYi which satisfies the above relation ships are illustrated in FIG. 4 where

RY60=Y60/SH

RY75=Y75/SH

RY90=Y90/SH

RY100=Y100/SH.

It has been reported in Japanese Patent No. 2994989 that since a tread having a profile satisfying the above equations is very round as shown in FIGS. 3 and 4, the footprint of the tire is in a longitudinally long elliptic shape that the ground contact width is small and the ground contact length is large, and the noise performance and aquaplaning performance can be improved. If the values of RY60, RY75, RY90 and RY100 are less than the above ranges, the tread portion 2 becomes flat and the profile of the tire external surface 2A approaches the profile of conventional tires. If they are more than the above ranges, the tire external surface 2A including the tread portion 2 has a markedly convex profile and the ground contact width becomes excessively small, so necessary running performances in normal running operation cannot be secured.

Since the aspect ratio of tire, the tire maximum section width, the tire maximum height and the like can be approximately determined from tire standards such as JATMA and ETRTO, the ranges of RY60, RY75, RY90 and RY100 can be readily calculated if the tire size is previously determined. Therefore, the tire external surface 2A can be appropriately determined by depicting it in a smooth curve from the tire equatorial point CP to the point P mentioned above so as to satisfy the ranges of RY60, RY75, RY90 and RY100 at respective positions and so as to gradually decrease the radius RC of curvature.

It is preferable that the above-mentioned tire have a ground contact width, which is an axial distance between axially outermost edges of a footprint formed when a tire contacts a ground, within the range of 50 to 65% of the tire maximum section width SW under conditions of the normal internal pressure and a load of 80% of the normal load. If the ground contact width is less than 50% of the tire maximum section width SW, the wandering performance deteriorates under normal running conditions and uneven wear is easy to occur due to uneven ground contact pressure. If the ground contact width is more than 65% of the tire maximum section width SW, the ground contact width is excessively large and it is difficult to simultaneously achieve both good passing noise performance and good aquaplaning performance.

Since such a special profile has the feature that the region of the sidewall portion is short, it is possible to further improve the runflat durability in combination with the properties of the rubber composition of the side portion reinforcing layer by adopting the profile in a runflat tire. Moreover, it is also possible to reduce the volume of a rubber in a side portion reinforcing layer 11 and, therefore, weight reduction and improvement in riding comfort of runflat tires can be achieved. On the other hand, the amount of deformation in the tread portion 2 having a large rubber volume becomes larger as compared with tires having a normal profile. Moreover, carcass cords using a highly heat-resistant aramid fiber can become more advantageous also for tires with such a special profile.

### Examples

### Examples 1 and 2 and Comparative Examples 1 and 2

<Adjustment of Polyparaphenylene Terephthalamide (PPTA) Masterbatch>

Masterbatches containing polyparaphenylene terephthalamide (PPTA) and stearic acid were adjusted on the basis of Table 1.

TABLE 1

| | % by mass |
|---|---|
| Para-aramid fiber^{(Note 1)} | 50 |
| Silane coupling agent^{(Note 2)} | 6 |
| Vulcanization accelerator^{(Note 3)} | 0.3 |
| Sulfur^{(Note 4)} | 0.1 |
| Stearic acid^{(Note 5)} | 42 |

^{(Note 1)}Polyparaphenylene terephthalamide (PPTA): “Twaron” produced by Teijin, Ltd.
^{(Note 2)}Silane coupling agent: “Si69” produced by Degussa Co.
^{(Note 3)}Vulcanization accelerator: “NS” produced by Ouchi Shinko Chemical Industrial Co., Ltd. company.
^{(Note 4)}Sulfur: Insoluble sulfur “MU-CRON OT” produced by Shikoku Chemicals Corporation
^{(Note 5)}Stearic acid: “TSUBAKI” produced by NOF Corporation

<Preparation of Rubber Composition>

According to the compositions shown in Table 2, the components other than the insoluble sulfur and the vulcanization accelerator were kneaded at 150° C. for 4 minutes using a Banbury mixer. Using the next open roll, sulfur and a vulcanization accelerator were added to the resultant kneaded matters, followed by kneading at 80° C. for 3 minutes to afford unvulcanized rubber compositions 1 to 4, which were used for test production of tires.

The resulting unvulcanized rubber compositions were press vulcanized at 160° C. for 20 minutes to afford vulcanized rubber compositions, which were subjected to the evaluations of strength at break and viscoelastic property.

<Production of Runflat Tire>

Using the rubber compositions 1 to 4 given in Table 2 as side portion reinforcing layers, they were molded into the shape of a lining strip layer. They were then laminated with other tire components, so that unvulcanized tires were molded. The molded tires were subjected to press vulcanization at 160° C. for 120 minutes. Thus, runflat tires having a size of 215/45ZR17 were produced.

The runflat tires of Examples 1, 2 and Comparative Examples 1, 2 have the same basic structure shown in FIG. 1 and are the same except for the rubber compositions of their side portion reinforcing layers. In these examples, rayon cords were used for the carcass and the number of ply was one. The cord angle was 90° with respect to the tire circumferential direction. Moreover, two steel cord belt plies were used for a belt layer. The plies were laminated opposite at a cord angle of 24° with respect to the tire circumferential direction.

TABLE 2

| | | | Comparative | Comparative |
|---|---|---|---|---|
| | Example 1 | Example 2 | Example 1 | Example 2 |
| Combination No. | 1 | 2 | 3 | 4 |
| NR^{(Note 1)} | 70 | — | 70 | — |
| SBR^{(Note 2)} | — | 70 | — | 70 |
| BR^{(Note 3)} | 30 | 30 | 30 | 30 |
| Carbon black^{(Note 4)} | 50 | 50 | 50 | 50 |
| Stearic acid^{(Note 5)} | 0.5 | 0.5 | 2 | 2 |
| Zinc oxide^{(Note 6)} | 3 | 3 | 3 | 3 |
| Antioxidant^{(Note 7)} | 1 | 1 | 1 | 1 |
| Para-aramid fiber | 2 | 2 | — | — |
| masterbatch^{(Note 8)} | | | | |
| Sulfur^{(Note 9)} | 5 | 5 | 5 | 5 |
| Accelerator^{(Note 10)} | 2 | 2 | 2 | 2 |
| Durometer A | 76 | 79 | 75 | 75 |
| hardness | | | | |
| TB(Mpa) | 15.3 | 16.8 | 9.45 | 8.54 |
| (E*)Mpa | 9.1 | 10.2 | 7.6 | 8.2 |
| E″/(E*)² × | 5.5 | 6.7 | 3.8 | 3.8 |
| 10⁻⁹Pa⁻¹ | | | | |
| tanδ index | 87 | 82 | 100 | 98 |
| Runflat durability | 206 | 212 | 100 | 104 |

^{(Note 1)}NR: RSS #3
^{(Note 2)}SBR-1: Commercial name “SL574” produced by JSR Corporation (1,2-syndiotactic polybutadiene; crystal content = 0% by mass)
^{(Note 3)}BR: “VCR412” produced by Ube Industries, Ltd.
^{(Note 4)}Carbon black (FEF): DIABLACK E produced by Mitsubishi Chemical Corporation (N₂SA: 41 m²/g, DBP oil absorption: 115 ml/100 g)
^{(Note 5)}Stearic acid: “TSUBAKI” produced by NOF Corporation
^{(Note 6)}Zinc oxide: “Zinc Oxide Type 2” produced by Mitsui Mining and Smelting Co., Ltd.
^{(Note 7)}Antioxidant: ANTIGENE 6C, N-(1,3-dimethylbutyl)-N′-phenyl-p-phenylenediamine, produced by Sumitomo Chemical Co., Ltd.
^{(Note 8)}Polyparaphenylene terephthalamide (PPTA) masterbatch: in combinations given in Table 1.
^{(Note 9)}Sulfur: Insoluble sulfur “MU-CRON OT” produced by Shikoku Chemicals Corporation
^{(Note 10)}Vulcanization accelerator: “Nocceler NS” (N-tert-butyl-2-benzothiazolylsufenamide) produced by Ouchi Shinko Chemical Industrial Co., Ltd.

The following evaluations were performed. The results of the evaluations are shown in Table 2.

<Viscoelastic Property>

As to rubber specimens of a side portion reinforcing layer adjusted by compositions 1 through 4, E″ (loss elastic modulus), E* (complex elastic modulus) and tan δ were measured using a viscoelasticity spectrometer manufactured by Iwamoto Corporation at a measurement temperature of 70° C., an initial strain of 10%, a dynamic strain of ±1% and a frequency of 10 Hz, and then E″/(E*)² was calculated.

The tan δ index represents a relative value determined by taking the tan δ value of Comparative Example 1 as 100.

<Strength at Break>

In accordance with JIS K6251 “Vulcanized Rubber and Thermoplastic Rubber, Determination of Tensile Properties”, a tensile test was carried out using type 3 dumbbell specimens made of the vulcanized rubber sheets and determined the strength (TB) at break at 23° C.

<Runflat Durability>

Respective sample tires were caused to run on a drum tester at an internal pneumatic pressure of 0 kPa, a velocity of 80 km/h and under a longitudinal load (4.14 kN), and the running distances until tires burst were measured. The Examples and Comparative Examples were evaluated using an index which is 100 for Comparative Example 1. The larger the value, the better the runflat durability is.

(Durability)=(Running distance of tested tire)÷(Running distance of Comparative Example 1)×100

### Examples 3 to 7 and Comparative Examples 3 to 7

Run flat tires in which the side portion reinforcing layers of formulation 1 and formulation 3 used Example 1 and Comparative Example 1 were used and the materials and structures of the carcass plies were changed were produced in the same manner as Example 1.

The basic structure of the runflat tires are as depicted in FIG. 1, and the same specification except for the materials and structures of carcasses given in Table 3 was used. The basic specification is as follows:

Carcass: one ply; cord angle=90° with respect to the circumferential direction.

Belt layer: two steel cord belt plies, laminated opposite at a cord angle of 24° with respect to the tire circumferential direction.

Side portion reinforcing layer: the maximum thickness of rubber=10.0 mm.

In Table 3, the twisting coefficient T is represented by the following formula (1):

T=N×√{(0.125×D/2)/ρ}×10⁻³ (1)

The rayon fiber cords had a specific gravity ρ of 1.51 and the aramid fiber cords had a specific gravity p of 1.44.

As to the tread profile, tires were used which have substantially the same profile within the ranges of RY60=0.05 to 0.1, RY75=0.1 to 0.2, RY90=0.2 to 0.4, and RY100=0.4 to 0.7.

TABLE 3

| | | | | | Compar- | Compar- | Compar- | | | Compar- | Compar- |
|---|---|---|---|---|---|---|---|---|---|---|---|
| | | | | | ative | ative | ative | | | ative | ative |
| | | Example 3 | Example 4 | Example 5 | Example 3 | Example 4 | Example 5 | Example 6 | Example 7 | Example 6 | Example 7 |
| Composition of side portion | | 1 | 1 | 1 | 3 | 3 | 3 | 1 | 1 | 3 | 3 |
| reinforcing layer | | | | | | | | | | | |
| Carcass | Cord material | Aramid | Aramid | Aramid | Aramid | Aramid | Aramid | Rayon | Aramid | Rayon | Aramid |
| | Cord composition | 1100 | 1100 | 1100 | 1100 | 1100 | 1100 | 1840 | 1100 | 1840 | 1100 |
| | (dtex) | | | | | | | | | | |
| | Total nominal | 2200 | 2200 | 2200 | 2200 | 2200 | 2200 | 3680 | 2200 | 3680 | 2200 |
| | fineness (dtex) | | | | | | | | | | |
| | Specific gravity of | 1.44 | 1.44 | 1.44 | 1.44 | 1.44 | 1.44 | 1.51 | 1.41 | 1.51 | 1.41 |
| | cord | | | | | | | | | | |
| | First twisting N | 53 | 68 | 68 | 53 | 68 | 68 | 48 | 44 | 48 | 44 |
| | (turns/10 cm) | | | | | | | | | | |
| | Second twisting N | 53 | 68 | 68 | 53 | 68 | 68 | 48 | 44 | 48 | 44 |
| | (turns/10 cm) | | | | | | | | | | |
| | Twisting | 0.5179 | 0.7745 | 0.6622 | 0.5179 | 0.7745 | 0.6622 | 0.5924 | 0.43 | 0.5924 | 0.43 |
| | coefficient T | | | | | | | | | | |
| | Cord end number | 53 | 53 | 53 | 53 | 53 | 53 | 51 | 53 | 51 | 53 |
| | (cords/5 cm) | | | | | | | | | | |
| | E* of carcass | 5.7 | 5.7 | 10.3 | 5.7 | 5.7 | 10.3 | 5.7 | 5.7 | 5.7 | 5.7 |
| | topping rubber | | | | | | | | | | |
| | (Mpa) | | | | | | | | | | |

| | | | | | | | | | | |
|---|---|---|---|---|---|---|---|---|---|---|
| Run flat durability | 227 | 243 | 260 | 120 | 129 | 134 | 200 | 191 | 100 | 93 |

<Evaluation of Runflat Durability>

The runflat durability was evaluated in the same method as Example 1.

Comparisons of Example 3 to Comparative Example 3, Example 4 to Comparative Example 4 and Example 5 to Comparative Example 5 show that in the cases of using carcasses of the same aramid fiber cords, the runflat durability is greatly improved by the use of composition 3 instead of composition 1 of the side portion reinforcing layer.

Comparisons of Example 6 to Comparative Example 6 and Example 7 to Comparative Example 7 show that in the cases of using carcasses of the same rayon fiber cords, the runflat durability is greatly improved by the use of composition 3 instead of composition 1 of the side portion reinforcing layer.

In comparison of Examples 3 through 5 and Example 7, it is shown that the twisting coefficient T is preferably within the range of 0.5 to 0.8.

It should be construed that the embodiments and the Examples shown herein are non-limiting and only illustrative. It is intended that the scope of the present invention includes not only the description provided above but all meanings equivalent to the claims and all modifications within the range of equivalence to the claims.

### INDUSTRIAL APPLICABILITY

The present invention is directed to a rubber composition for side reinforcement excellent in runflat performance and a runflat tire using the same, and can be applied not merely to tires for passenger cars but also to tires for light trucks and tires for trucks and buses.

1-11. (canceled)

12. A side portion reinforcing layer for a runflat tire comprising a carcass extending from a tread portion to a bead core of a bead portion via a sidewall portion, a belt layer disposed inside the tread portion and on the radially outward of said carcass, and a side portion reinforcing layer which is disposed inside both the sidewall portion and said carcass and has a crescent cross-sectional shape extending from the center portion having a maximum thickness toward both the radially inward and the radially outward with gradual decrease in thickness, wherein the side portion reinforcing layer for a runflat tire is made of a rubber composition prepared by blending 0.1 to 50 parts by mass of a reinforcing material of polyparaphenylene terephthalamide based on 100 parts by mass of a rubber component comprising 20 to 80% by mass of a natural rubber and/or a polyisoprene rubber and 80 to 20% by mass of a polybutadiene rubber.

13. The side portion reinforcing layer according to claim 12 wherein the reinforcing material is polyparaphenylene terephthalamide and/or a masterbatch comprising the polyparaphenylene terephthalamide and stearic acid.

14. The side portion reinforcing layer according to claim 12 or 13, wherein the complex elastic modulus (E*) of the rubber composition is 10 Mpa or more.

15. A runflat tire using the side portion reinforcing layer of claim 12.

16. The runflat tire according to claim 15, wherein said carcass is made of a carcass ply made of a carcass cord which is arranged at an angle of 45 to 90° with respect to the circumferential direction of the tire and is covered with a topping rubber, said carcass cord being an aramid fiber cord.

17. The runflat tire according to claim 16, wherein said carcass cord has a two-strand twist structure in which two first-twisted filament bundles are twisted together by second-twisting.

18. The runflat tire according to claim 16 or 17, wherein said carcass cord has a twisting coefficient T represented by the following formula ranging from 0.5 to 0.8:
T=N×√{(0.125×D/2)/ρ}×10⁻³
wherein N is a second twisting number (turns/10 cm), D is a total nominal decitex (fineness) and ρ is a specific gravity of a cord material.

19. The runflat tire according to claim 16, wherein said topping rubber of said carcass ply has a complex elastic modulus (E*) within a range of 5 to 13 MPa.

20. A runflat tire according to claim 15, wherein in the tire meridian cross section at a normal internal pressure condition where the tire is attached to a regular rim and inflated at a normal internal pressure, when a point on the tire external surface which is apart from the tire equatorial plane C by a distance SP which is 45% of the tire maximum section width SW is assumed to be P, the radius of curvature, RC, of the tire external surface decreases gradually from an equatorial point CP at which the tire external surface intersects with the tire equatorial plane C to said point P, and the following relationships are satisfied when Y60, Y75, Y90 and Y100 denote, respectively, radial distances between the points on the tire external surface apart from the tire equatorial plane C by 60%, 75%, 90% and 100% of the half width (SW/2) of the tire maximum section width SW and the normal CX with respect to the tire equatorial plane C at the equatorial point P, and SH denotes the tire section height:
0.05<Y60/SH≦0.1
0.1<Y75/SH≦0.2
0.2<Y90/SH≦0.4
0.4<Y100/SH≦0.7

21. A method for producing a side portion reinforcing layer for a runflat tire that comprises a carcass extending from a tread portion to a bead core of a bead portion via a sidewall portion, a belt layer disposed inside the tread portion and on the radially outward of said carcass, and a side portion reinforcing layer which is disposed inside both the sidewall portion and said carcass and has a crescent cross-sectional shape extending from the center portion having a maximum thickness toward both the radially inward and the radially outward with gradual decrease in thickness, the method comprising:
a step of preparing a masterbatch comprising polyparaphenylene terephthalamide and/or the polyparaphenylene terephthalamide and stearic acid, and
a step of preparing a rubber composition by mixing the masterbatch, a natural rubber and/or a polyisoprene rubber, and a polybutadiene rubber,
wherein the rubber composition is composed of a rubber composition prepared by blending 0.1 to 50 parts by mass of a reinforcing material of polyparaphenylene terephthalamide based on 100 parts by mass of a rubber component comprising 20 to 80% by mass of a natural rubber and/or a polyisoprene rubber and 80 to 20% by mass of a polybutadiene rubber.

22. The method for producing a side portion reinforcing layer for a runflat tire according to claim 21, wherein said masterbatch comprises polyparaphenylene terephthalamide and stearic acid.
